(19) United States
(12) Patent Application Publication
(10) Pub. No.: US 2002/0057167 A1
(43) Pub. Date: May 16, 2002

(54) Linear filter

(76) Inventors: Ming Yeh, Taoyuan Hsien (TW); Allen Chou, Taoyuan Hsien (TW); Jau-Jen Du, Taoyuan Hsien (TW)

Correspondence Address: Mathews, Collins, Shepherd & Gould, P.A., 100 Thanet Circle, Suite 306, Princeton, NJ, 08540-3674, US

(21) Appl. No.: 09/748,944

(22) Filed: Dec. 27, 2000

(30) Foreign Application Priority Data
Apr. 21, 2000 (TW) 89206579

(51) Int. Cl. H01F 27/29

(52) U.S. Cl. 336/192

(57) ABSTRACT

A linear filter is disclosed including a metal core, a bobbin surrounded said metal core for spinning around electric lines to form coils thereon, a plurality of metal pins disposed on said bobbin for providing electrical signals to said coils, and a plug disposed between said metal core and said bobbin for filling a gap between said metal core and said bobbin to prevent said metal core from moving.

### FIELD OF THE INVENTION

The present invention is related to a linear filter, and more especially to a linear filter wherein the metal core and the bobbin of the linear filter are locked together tightly by using a plug.

### BACKGROUND OF THE INVENTION

The monitor of an ordinary personal computer (PC) is capable of adjusting parameters, such as length-to-width ratio, top-to-bottom ratio, contrast, brightness, H-size, V-size, H-phase, V-center, pincushion, keystone and rotation, by digital or analog adjusting modes. A linear filter is used for providing these adjusting functions.

FIG. 1 schematically shows a conventional linear filter. The linear filter includes a bobbin 11, a metal core 12 in the center of the bobbin 11, and two sets of electric lines 13 spun around the outer surface of the bobbin 11. The bobbin 11 is composed of two half-bobbins assembled together by a plurality of protruding portions and a plurality of corresponding concave portions, as shown in FIG. 2. In order to spin the electric lines rapidly, the linear filter further includes a gear 24 disposed on the outer surface of the bobbin 11 for spinning the electric lines 13. After a predetermined number of spins are obtained, the ends of the electric lines are fixed on metal pins 23 of the linear filter for conducting the electric lines 13. The position of the metal pins 23 is not specified, and they can be disposed either on the upper surface of the bobbin or the base of the bobbin.

Before the bobbin and metal core are fixed, there is a gap between the bobbin and the metal core. When the linear filter disposed in a monitor is working, any movement of the monitor will possibly arise a slide of the metal core. This situation will change an induced current of the linear filter, and the performance of the linear filter will be seriously affected.

Conventionally, the metal core and the bobbin are fixed by spot gluing 31, as shown in FIG. 3, and the glue is usually dried by baking. Although this method has been used for many years in the production line, problems are still existed.

1. Long Production Time:

Only gluing can not fix the metal core and the bobbin together. It must wait until the glue is totally dried to enhance the fixing strength. Therefore, it must take a lot of time to bake the glue so that the production efficiency is lowered.

2. Low Yield:

As described above, baking is an essential step for producing the conventional linear filter. However, when baking, the volume of the glue will be changed and this volume change will result in stresses on the metal core. Actually, some metal cores are proved to be broken by thermal stresses in practice. In addition, the glue on the metal core will cause the metal core to be unevenly heated so as to unevenly affect the magnetic property of the metal core. Both of these two reasons will lower the yield.

3. High Energy Waste:

The baking process needs to be done for hours, and this will waste lot of energy.

4. Toxicity and Environmental Damage:

When baking, many toxic gases will be generated in the glue at high temperature. The glues used for fixing metal core and the bobbin are hard to be decomposed naturally and easily.

It is therefore attempted by the present applicant to deal with the above situation encountered with the prior art.

### SUMMARY OF THE INVENTION

An object of the present invention is to provide a novel linear filter which metal core and the bobbin of the linear filter are fixed together by using a plug disposed between the metal core and the bobbin. Therefore, a gap between the metal core and the bobbin is filled by the plug so as to prevent the metal core from moving.

The linear filter of the present invention includes a metal core, a bobbin surrounded the metal core for spinning around electric lines to form coils thereon, a plurality of metal pins disposed on the bobbin for providing electrical signals to the coils, and a plug disposed between the metal core and the bobbin for filling a gap between the metal core and the bobbin to prevent the metal core from moving.

According to the present invention, the inner wall of the bobbin has an indent with a plurality of ditches allowing the plug to be engaged therein. Preferably, the gap is a T-shaped gap and the plug is a T-shaped plug for engaging with the T-shaped gap. Preferably, the gap is a semicircle-shaped gap and the plug is a semicircle-shaped plug for engaging with the semicircle-shaped gap.

The bobbin is composed of two half-bobbins assembled together by a plurality of protruding portions and a plurality of corresponding concave portions.

A linear filter of the present invention includes a bobbin for spinning around electrical lines to form coils thereon, wherein the bobbin has a hole in center, a metal core disposed in the hole of the bobbin, a plurality of metal pins disposed on the bobbin for providing electrical signals to the coils, an indent between the bobbin and the metal core and having a plurality of ditches for disposing a plug therein and locking the plug tightly by the ditches, and the plug for filling the indent to prevent the metal core from moving.

### BRIEF DESCRIPTION OF THE DRAWINGS

FIG. 1 schematically shows a conventional linear filter;

FIG. 2 schematically shows the detail structure of the bobbin, where the bobbin is composed of two half-bobbins assembled together;

FIG. 3 schematically shows the conventional linear filter foxed by spot gluing;

FIG. 4 schematically shows a linear filter of the present invention;

FIG. 5 schematically shows a horizontal-type linear filter of the present invention; and

FIG. 6 schematically shows a vertical-type linear filter of the present invention.

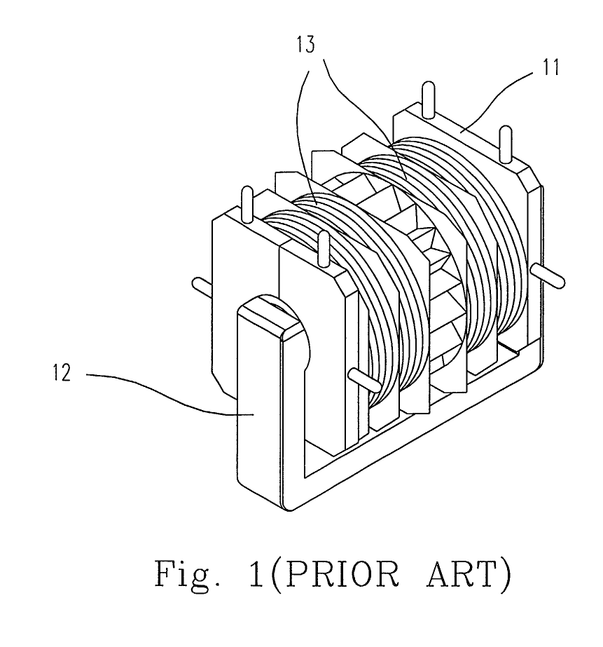

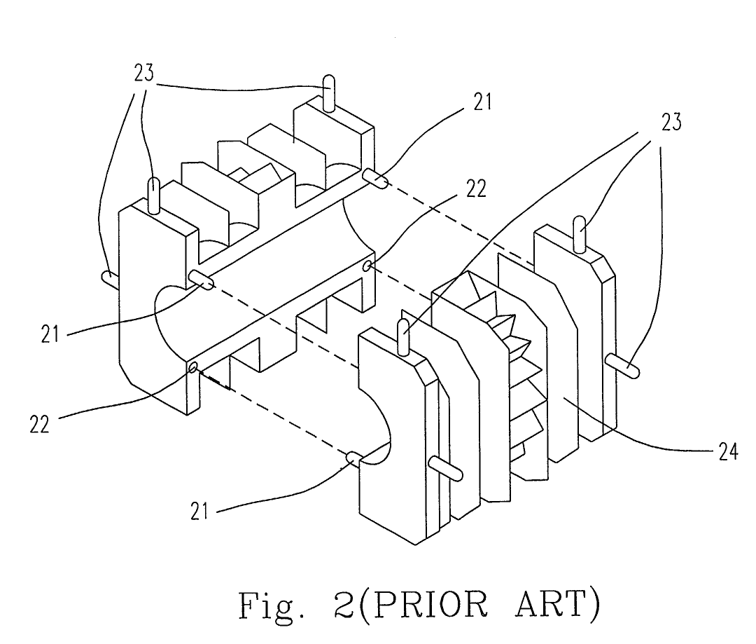

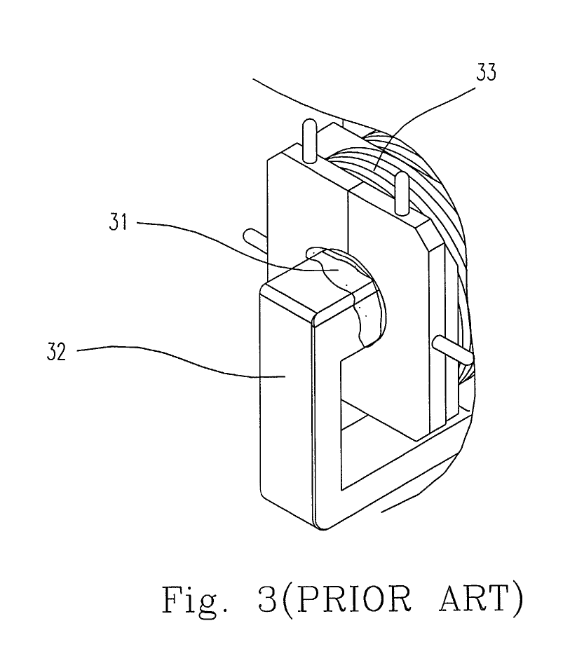

### DETAILED DESCRIPTION OF THE PREFERRED EMBODIMENTS

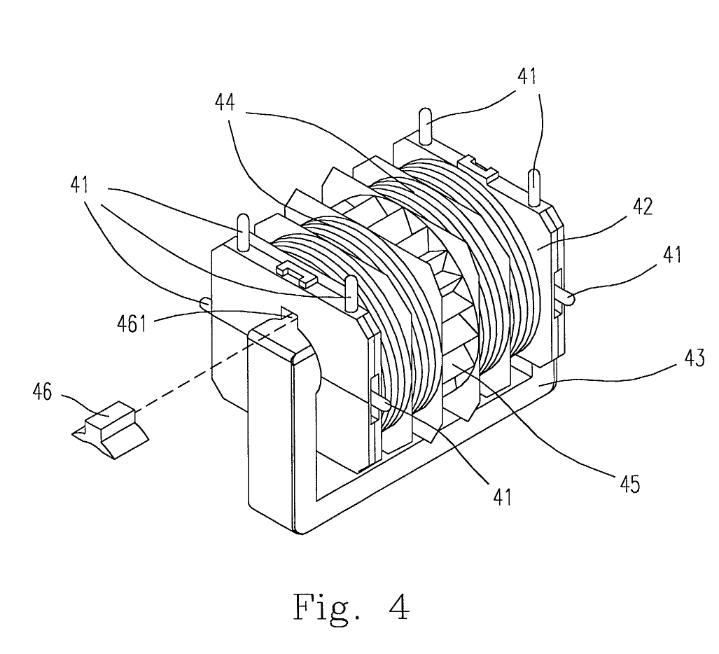

As shown in FIG. 4, the linear filter of the present invention includes a metal core 43, a bobbin 42, a plurality of metals pins 41, electric lines 44 and a plug 46. The bobbin 42 surrounded the metal core 43 is used for spinning around electric lines 44 to form coils thereon, a plurality of metal pins 41 disposed on the bobbin 42 for providing electrical signals to the coils, and a plug 46 disposed between the metal core 43 and the bobbin 42 for filling a gap between the metal core 43 and the bobbin 42 to fix the metal core 43 and the bobbin 42. The bobbin 42 is preferably composed of two half-bobbins assembled together by a plurality of protruding portions and a plurality of corresponding concave portions.

In order to spin the electric lines rapidly, the linear filter further includes a gear 45 disposed on the outer surface of the bobbin 42 for spinning the electric lines 44. After a predetermined number of spins are obtained, the ends of the electric lines are fixed on metal pins 41 of the linear filter for conducting the electric lines 44.

The characteristic of the present invention is that the meal core and the bobbin of the linear filter are fixed together by using a plug disposed between the metal core and the bobbin. According to the present invention, the inner wall of the bobbin has an indent with a plurality of ditches allowing the plug to be engaged therein tightly. The ditches can be formed by machining. When the plug is engaged in the indent, the plug will tightly fill the gap and fix the metal core in the bobbin by friction. Even the linear filter is deformed by external force, the plug still can fix the metal core in the bobbin, thereby maintaining the performance of the linear filter. The plug is preferably formed by a material with a high friction coefficient.

The shapes of the indent and the plug are not specified. For example, the indent can be a T-shaped or a semicircle-shaped indent and the plug is a corresponding T-shaped or semicircle-shaped plug.

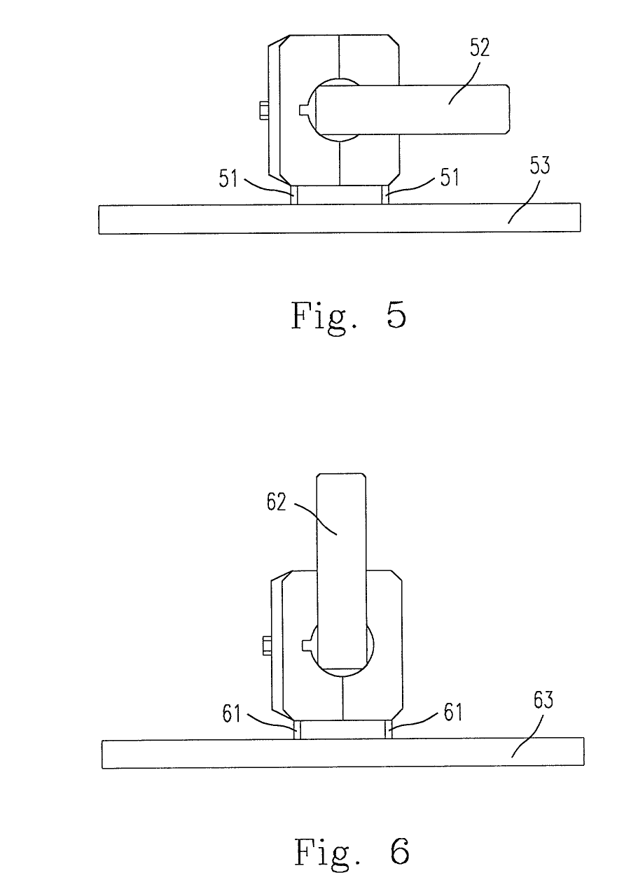

The position of the metal pins 41 is not specified, and they can be disposed either on the upper surface of the bobbin or the base of the bobbin. The performance of the linear filter is changed with the relative position of the metal core and the metal pins, when the linear filter is set on a board. As shown in FIG. 5, when the angle between the metal core 52 and the metal pins 51 is 90 degrees, this linear filter is called “horizontal-type linear filter” and the altitude of this linear filter in the board 53 is reduced. As shown in FIG. 6, when the angle between the metal core 62 and the metal pins 61 is 180 degrees, this linear filter is called “vertical-type linear filter” and the surface area of this linear filter occupied on the board 63 is reduced.

In conclusion, the linear filter of the present invention has a novel structure which can fix the metal core and the bobbin together tightly by using a plug. The linear filter of the present invention can easily solve the problems, such as long production time, low yield, high energy waste, toxicity and environmental damage, encountered with the prior art.

While the invention has been described in terms of what are presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A linear filter, comprising:
a metal core;
a bobbin surrounded said metal core for spinning around electric lines to form coils thereon;
a plurality of metal pins disposed on said bobbin for providing electrical signals to said coils; and
a plug disposed between said metal core and said bobbin for filling a gap between said metal core and said bobbin to prevent said metal core from moving.

2. The linear filter according to claim 1, wherein said gap is a T-shaped gap and said plug is a T-shaped plug for engaging with said T-shaped gap to prevent said metal core from moving.

3. The linear filter according to claim 1, wherein said gap is a semicircle-shaped gap and said plug is a semicircle-shaped plug for engaging with said semicircle-shaped gap to prevent said metal core from moving.

4. The linear filter according to claim 1, wherein said bobbin is composed of two half-bobbins assembled together by a plurality of protruding portions and a plurality of corresponding concave portions.

5. A linear filter, comprising:
a bobbin for spinning around electric lines to form coils thereon, wherein said bobbin has a hole in center;
a metal core disposed in said hole of said bobbin;
a plurality of metal pins disposed on said bobbin for providing electrical signals to said coils;
an indent between said bobbin and said metal core and having a plurality of ditches for disposing a plug therein and locking said plug tightly by said ditches; and
said plug for engaging in said indent to prevent said metal core from moving.

6. The linear filter according to claim 5, wherein said bobbin is composed of two half-bobbins assembled together by a plurality of protruding portions and a plurality of corresponding concave portions.
